(19) United States
(12) Patent Application Publication
(10) Pub. No.: US 2025/0182543 A1
(43) Pub. Date: Jun. 5, 2025

(54) Method and Apparatus for Providing a Service in a Vehicle

(71) Applicant: Bayerische Motoren Werke Aktiengesellschaft, Muenchen (DE)

(72) Inventors: Albrecht Neff, Sunnyvale, CA (US); Philipp Rottgardt, Muenchen (DE)

(21) Appl. No.: 18/845,345

(22) PCT Filed: Nov. 25, 2022
(86) PCT No.: PCT/EP2022/083273

§ 371 Date: Sep. 9, 2024

(30) Foreign Application Priority Data
Apr. 5, 2022 (DE) 10 2022 108 097.8

(51) Int. Cl. G07C 5/08

(52) U.S. Cl. CPC G07C 5/0841

(57) ABSTRACT

A method of providing a service in a vehicle wherein the service is provided using at least one onboard service component and an external service component includes receiving a request for provision of the service in the vehicle. The method further includes determining at least one identification code of at least one of the group consisting of the external service component and the onboard service component, and determining release information for a cooperative provision of services for the vehicle using a release list and the at least one identification code. The method also includes releasing, by a release module of the vehicle, to provide the service in accordance with the release information, at least one onboard interface for at least one of the group consisting of the onboard service component and for the external service component.

The present application is the U.S. national phase of PCT Application PCT/EP2023/083273 filed on Nov. 25, 2022, which claims priority of German patent application No. 10 2022 108 097.8 filed on Apr. 5, 2022, the entire contents of which are incorporated herein by reference.

### TECHNICAL FIELD

The present disclosure relates generally to vehicles, and more particularly, to providing a service in a vehicle.

### BACKGROUND

In modern vehicles, networking with external components, such as a vehicle occupant's smartphone or cloud services, is becoming increasingly important.

Due to networking, the range of functions of a vehicle can be expanded to include services that are created by the interaction of an onboard service component and an external service component. And conversely, the range of functions of an external cloud service or external device can also be expanded by networking and interaction with a service component in the vehicle that provides the range of functions or data of the vehicle. The interaction of external and onboard service components is referred to as cooperative service provision. For example, the range of functions of the vehicle can be expanded to include music streaming, in which an external cloud-based service provides the audio streaming channels and a corresponding onboard range of services provides, for example, audio playback and suitable display and control elements in the vehicle. Thus, the music streaming service is provided cooperatively.

Services such as telephony and music, for example, can also be provided cooperatively between the vehicle and a mobile terminal device of a vehicle occupant by exchanging data via interfaces and protocols between onboard service components and external service components of the mobile terminal device.

As a further example, a range of services on a smartphone (for example a smartphone application such as the “MyBMW” app from BMW) can inform the user about the charge level of the vehicle battery or enable the control of vehicle functions from the smartphone (for example horn, parking heater, door locking), if the vehicle itself provides suitable service components and interfaces for this.

Reliable and error-free cooperative service provision is particularly important in the automotive sector, especially because of the corresponding consequences or dangers that may arise from the incorrect provision of services in a vehicle.

A reliable and error-free cooperative service provision is largely dependent on the compatibility and error-free nature of the service components involved, as well as possibly on other aspects that influence compatibility, such as the nature and configuration of the vehicle.

However, ensuring compatibility is complicated by the fact that the onboard and external service components involved are usually developed independently of each other and have different development and life cycles.

This is particularly evident in the example of the cooperative service provision between a vehicle and a commercially available smartphone with software and apps: Both systems are designed, developed and provided with updates independently of each other. In this respect, a one-time compatibility test of both systems with each other cannot be sufficient to ensure compatibility throughout the entire life cycle of a vehicle. This applies similarly to cloud services, which are typically also developed and further developed independently of specific vehicles.

In addition, a planned cooperatively provided service may not yet be able to be provided at the time of production of the vehicle, but may only be made possible by the subsequent provision of a cloud service or only by a software update of the smartphone or a smartphone app.

In addition to incompatibilities of the service components involved, there may also be other reasons that require a subsequent (temporary) deactivation of the cooperative service provision in order to ensure error-free and safe operation of the vehicle. The temporary deactivation should last at least until the problem is fixed.

An example of this is the discovery of a security vulnerability in the external service component, in particular in a cloud service, a smartphone app, or an implementation environment thereof (for example cloud server, smartphone operating system, communication stack).

A security vulnerability or incompatibility can also be eliminated by a software update on the side of the external service component (i.e. the cloud service, smartphone or smartphone app) or the onboard service component (i.e. onboard software).

There is a need, therefore, for the reliable and error-free provision of a service in a vehicle. The service may in particular be a service provided using at least one onboard service component and one external service component, preferably cooperatively. In addition, there is a need for appropriate devices for implementing reliable and error-free provision of a service in a vehicle.

### SUMMARY

At least some embodiments disclosed and claimed herein address one or more of the above-stated needs. For example, a method designed to prevent or reduce malfunctions in the vehicle resulting from incompatibilities or other failures of the service components.

In some embodiments, one or more of the above-stated needs is addressed by a method of providing a service in a vehicle. The service is provided using at least one onboard service component and one external service component, in particular as a cooperative service provision. The method includes receiving a request for the provision of the service in the vehicle. The method also includes determining an identification code of the external service component and/or an identification code of the onboard service component. The method further includes determining release information for the cooperative service provision for the vehicle, using a release list and the identification code of the onboard service component and/or the identification code of the external service component. At least one (onboard) interface for the onboard service component and/or for the external service component is released by a release module of the vehicle according to the release information to provide the service.

One aspect of one or more embodiments is that the release of at least one (onboard) interface for the onboard service component and/or for the external service component takes place only after a check by a release module in the vehicle. In this way, interfaces that are necessary for the provision of a service may remain deactivated if no corresponding release information is available. The vehicle can thus be operated in a safe mode as standard with regard to the provision of services and/or can fall back into such a mode as soon as no current or valid release information is available. This protects the vehicle from malfunctions that can emanate from the cooperative service provision, and can thus increase the safety of the vehicle.

In order to carry out the check, the method first determines identification codes of one or both of the service components involved after a corresponding request in order to identify them. However, the request does not have to be made immediately before the desired provision of the service in the vehicle, but can be made at some point previously, for example when starting the onboard computer, at regular times or at the last change/update. According to the method described, release information for the respective service is determined in the respective vehicle upon request.

Release information can be understood as a statement that indicates the extent to which the service in question is released, i.e. may be provided in the vehicle. The invention thus explicitly provides for not only to completely release or prohibit the provision of the service in the vehicle, but rather to grant releases at a functional level. This means that the provision of the service in the vehicle can be precisely controlled.

The determination of the release information is carried out using the identification code(s) and a release list. In particular, the release list can be a database or other data structure.

The release list may formulate minimum requirements that the components involved in the provision of the service, in particular the onboard service component and the external service component, must meet in order to allow the service to be provided in the respective vehicle. The requirements can refer, for example, to the onboard service component itself (software version, etc.) as well as to its implementation environment, i.e. the vehicle (optional equipment, software versions, year of manufacture, hardware versions, etc.). Likewise, the requirements relate to the external service component itself (software version of the smartphone app, software version of the cloud service, etc.) as well as its implementation environment (for example operating system version of the smartphone, server of the cloud service, etc.). In addition, the release list can formulate general requirements for the operating environment (location of the vehicle, time, etc.), for example to comply with legal framework conditions.

In one embodiment, the determination of the release information can be carried out by the release module. Accordingly, the method can also include: determining features of The cooperative service provision; transferring the features to a backend server by means of a mobile terminal device and/or by means of a communication module of the vehicle, wherein the release list is stored on the backend server; determining records of the release list using the features; transferring the records of the release list from the backend server to the vehicle, in particular by means of a mobile terminal device and/or by means of a communication module of the vehicle; and transferring the records to a database of the release module.

The determination of the release information is also carried out by the release module using the records and using the features of the cooperative service provision.

According to this embodiment, determining the release information is carried out by the release module in the vehicle, wherein the release list is stored on the backend server. In order not to have to transfer the complete release list to the vehicle, but only the records of the release list relevant to the requested service provision, features of the cooperative service provision are first determined.

The features may include, in particular, the following information: a set of attributes of onboard service components; a set of attributes of external service components; a set of identification codes of services and/or service scopes; and a set of a attributes of the vehicle, in particular vehicle identification, attributes of hardware and software components (for example versions, configurations), vehicle equipment, country of vehicle registration, country of vehicle user, geographic location of the vehicle.

A set can be understood as a collection of any number of elements. The set can be described by explicitly enumerating the elements contained therein (whitelist), explicitly enumerating the elements not contained (blacklist) or implicitly by an expression, possibly using wildcards.

An attribute of a service component (onboard or external) can be understood to mean a software version number or a serial number. An attribute of the onboard service component can also include attributes about the vehicle itself, in particular the chassis number, installed optional equipment, country of vehicle registration, etc.

The determined features are then transferred to a backend server according to the described embodiment. In particular, the transfer may take place by means of a mobile terminal device connected to the vehicle and/or by means of a communication module of the vehicle. The mobile terminal device can, for example, be connected to a head unit of the vehicle, in particular via Bluetooth or WLAN, and can establish a connection to the backend server via a mobile data connection. The communication module can be connected to the backend server via any wireless technology (for example LTE, 5G, WLAN, etc.) or other technologies, such s communication via charging plug.

After the features have been transferred, determination of the records of the release list is carried out using the features. In particular, this can include filtering the release list for records that are relevant to the request, i.e. that match one or more of the transferred features. This optional optimization step of transmitting features to the backend server and filtering current and, if necessary, future relevant records for this specific vehicle prevents records from being transferred back to the vehicle that are not relevant at all, for example because they relate to a different software version of the service component of the vehicle. More data must be transferred from the backend server to the vehicle than is necessary in the current configuration, for example in order to have records already available in the vehicle for the time after the next software update.

The records determined can be transferred to the vehicle in particular via the communication paths described above, in particular via a communication module or via a mobile terminal device.

In the vehicle, the received records are finally transferred to a database of the release module, which now determines the release information based on the received records.

According to this embodiment, the release information is determined in the vehicle. This offers the advantage that further information which is only available in the vehicle can be included in order to determine the release information. For example, a check can be carried out as to whether a vehicle fault memory contains a fault code or whether the vehicle is in a specific geographic location. Another advantage is that the vehicle can react independently and immediately to changes (for example software updates the service components) and of independently generate release information without having to rely on online communication with the backend server. This is particularly possible if a large set of valid records (for example validity period not yet exceeded) is already available in the vehicle.

In an alternative embodiment, the release information is determined by a backend server and the method also includes: determining features of the cooperative service provision; transferring the features to a backend server by means of a mobile terminal device and/or by means of a communication module of the vehicle, wherein the release list is stored on the backend server; determining the release information by the backend server, furthermore using the features of the cooperative service provision; transferring the release information from the backend server to the vehicle, in particular by means of a mobile terminal device and/or by means of a communication module of the vehicle; and transferring the release information to the release module.

Optionally, the method may also include (one-time or recurring) evaluating the validity of the release information by the release module, in particular using the respective current features of the cooperative service provision.

The main difference from the previously described embodiment is that determining the release information takes place on the backend server and not in the vehicle. This assumes that the backend server has all the necessary information for determining the release information. One advantage of this embodiment, however, is that only the release information and not records of the release list have to be transferred back from the backend server to the vehicle. The release information can have a significantly smaller amount of data than the (possibly large) set of records. As a result, the communication connection between the vehicle and the backend server or the vehicle and the mobile terminal device is loaded to a lesser extent and can be used more efficiently. In addition, the logic for determining the release information in the backend can be updated at any time and, if necessary, supplemented with other data sources.

The optional evaluation of the validity of the release information by the release module can be carried out either once or recurringly. Recurring evaluation has the advantage that features that have changed in the meantime lead to a new evaluation. The recurring evaluation can be triggered by changing the features (for example in the case of software updates, configuration changes), or at certain time intervals, or in connection with the starting process or sleeping process of the vehicle. In addition, a recurring evaluation may be carried out depending on the request for service provision.

In one embodiment, releasing the at least one interface according to the release information may involve at least one of the following: activation of a software interface, in particular for use by an onboard service component; activating a hardware component of the vehicle; starting a software process in the vehicle; activating a communication interface, in particular an onboard network interface or network port, and/or a network connection in the vehicle; activating and/or extending an interface, in particular a communication interface, to an external service component; and providing the release information in the vehicle.

According to this embodiment, the interfaces or (software) processes necessary for the service provision are activated in the vehicle, which are necessary for the provision of the service. In order to achieve maximum safety, it is preferred that the interfaces or processes in the vehicle are deactivated as standard.

Activating or deactivating interfaces can be carried out using a mechanism developed in accordance with ISO 26262 (Automotive Functional Safety) and/or ISO 21434 (Automotive Cybersecurity).

In one embodiment, the service (cooperative service provision) can be a control of a parking heater, a horn or a locking system of the vehicle.

In one embodiment, at least one, preferably each record on the release list includes one or more of the following data: a set of attributes of onboard service components; a set of attributes of external service components; a set of identification codes of services and/or service scopes; a set of attributes of the vehicle, in particular vehicle identification, hardware and software components, vehicle equipment, country of vehicle registration, country of vehicle user, geographic location of the vehicle; and a set of attributes of an implementation environment of the external service component, in particular versions of interfaces, hardware, operating system.

Here determining the release information includes a comparison with at least one attribute of the onboard service component and/or at least one attribute of the external service component or its implementation environment and/or at least one attribute of the vehicle.

As already described, the sets can be described in particular in the form of a whitelist or blacklist.

In one embodiment, at least one record of the release list can also contain an indication of the validity period. Determining the release information may include a comparison of the validity period of the record with a system time of the vehicle and/or a system time of an implementation environment of the external service component and/or a system time provided online or by satellite.

Likewise, release information issued by the backend server can include a validity period indication.

Preferably, the service will not be provided or will be provided on a reduced basis if the system time of the vehicle and/or the system time of the vehicle component is outside the range specified by the validity period specification. Preferably, the system time used is protected against manipulation, for example by a protection mechanism against resetting the system time in the vehicle or by comparison with a trusted time server.

Specifically, in the embodiment described, the records can be provided with an expiration date, which is set, for example, to three days after the record has been released in the release list. This means that the service in question can be operated in the vehicle for a maximum of three days, unless a more recent record with an extended expiry date is provided. This can prevent a service from being provided that is no longer permitted according to the current release list due to the failure to update the records.

The same applies to a validity period specification of release information provided by the backend server.

In another embodiment, at least one record of the release list may also include a geographic area specification and determining the release information may include a comparison of the geographic area specification of the record with a (geographic) location of the vehicle and/or a (geographic) location of an implementation environment of the external service component.

The geographic area specification can consist of countries or sets of geo-coordinates that describe areas, for example. Furthermore, the geographic area specification can consist of elements such as road types (for example motorway, country road, intersection), street names, cities, as well as geofences around certain categories of points of interest (for example petrol stations, airports, traffic lights). This embodiment allows a particular service to be authorized or disallowed only in certain geographic regions, such as a particular country.

In another embodiment, at least one record of the release list and/or the release information can be digitally signed and the method can also include verifying at least one digital signature of a record and/or one digital signature of the release information by the release module.

Preferably, the release module does not grant a release for the provision of the service, or only grants it to a limited extent, if the verification of the digital signature fails.

This embodiment further increases the safety of the service provision by verifying the integrity of individual records. If records are changed intentionally or the release information is falsified by a transmission error, this leads to the digital signature becoming invalid. The (precautionary) restriction or prevention of the service provision in such cases further increases vehicle safety.

In another embodiment, at least one record of the release list may include at least one check condition. The check condition can be in particular the absence of a fault code in the vehicle or the validity of a digital signature of a software module of the vehicle. In addition, the check condition may refer to features of current vehicle conditions or operating conditions, a current condition or data of vehicle functions, a current value of sensor measurements of the vehicle, or a current operating condition of the external service or its implementation environment. Furthermore, the method may also include determining whether the check condition is met in the vehicle.

Again, it is preferred that the release module does not grant permission for the service provision, or only grants it to a limited extent, if the check condition is not met. The determination of whether the check condition is met can also be carried out repeatedly at certain times or events or continuously.

The advantages are similar to those of the embodiment described above.

The object is also achieved by a computer-readable storage medium. The computer-readable storage medium contains instructions that cause at least one processor to implement a method as described above if the instructions are executed by the at least one processor.

Furthermore, the object is achieved by a release module in a vehicle. The release module is preferably designed to perform one or more of the following: determining features of a cooperative service provision in a vehicle, in particular between an onboard service component and an external service component; receiving and/or sending a request regarding the provision of a service in the vehicle, wherein the request includes an identification code of an external service component and/or an identification code of an onboard service component; receiving records of a release list from a mobile terminal device and/or a communication module of the vehicle and storing the records in a database of the release module; determining and/or receiving release information for the cooperative service provision using a release list, in particular also using the current features of the cooperative service provision; releasing at least one (onboard) interface for the onboard service component and/or for the external service component to provide the service, in accordance with the release information, in particular by means of an isolation module as described below; storing determined or received release information, in particular for later use; checking release information for validity, in particular temporal validity and/or geographic validity, possibly followed by a request for new release information; and re-determining the features of the cooperative service provision and checking whether the validity of previously stored release information is still valid with regard to the newly determined features.

With regard to the release module, there are similar technical advantages and effects as those already described in connection with the method described above.

Furthermore, one or more of the needs stated further above can be achieved by an isolation module in a vehicle. The isolation module may be configured to cause at least one control unit and/or software component of the vehicle to activate or deactivate an interface for the onboard service component and/or for the external service component, in particular by at least one of the following: allowing or preventing the execution of software, in particular at any operating system level of the vehicle or the onboard service component; transferring or absorbing data and/or control commands, in particular by means of a communication path between the vehicle and the onboard service component and/or between the onboard service component and the external service component; sending fault codes, in particular on a communication path between the vehicle and the onboard service component and/or between the onboard service component and the external service component. The isolation module is preferably connected to a release module, in particular as described above.

For example, at the level of the operating system (or between the operating system and the onboard service component), the isolation module can enable or prevent the execution of the onboard service component in software.

Furthermore, the isolation module can be implemented as a kind of proxy between a vehicle API and the onboard service component, thus ensuring access control between the interfaces provided by the vehicle and the onboard service component or external service component. Alternatively, the isolation module can be implemented as a kind of proxy between the onboard service component and the external service component, thus ensuring access control between the respective interfaces of the onboard service component and external service component.

The access control can also take the form of regulating access by returning default values (for example “0”) or error values (for example “0xFF”) or error codes provided in the API.

Preferably, with several services the isolation module is able to carry out this access control individually for each service and for each interface.

With regard to the isolation module, there are similar technical advantages and effects as those already described in connection with the method discussed above.

Furthermore, another aspect of the disclosure is a vehicle that has a release module, at least one isolation module, at least one onboard service component and a communication module. The release module is as described above and the at least one isolation module as described above, and implement the method as described above. The vehicle is designed to provide a service using the at least one onboard service component and an external service component, in particular as a cooperative service provision.

Preferably, the vehicle also has a position determining module, in particular a GPS module, and/or a mechanism for determining a system time provided onboard or externally.

With regard to the vehicle, there are similar technical advantages and effects as those already described in connection with the method discussed above.

In addition, the object is achieved by a system, in particular for implementing a method as described above. The system contains a vehicle as described above, an external service component, and a backend server.

In a preferred embodiment, the system also has a mobile terminal device that is designed to: transfer features of the cooperative service provision of the vehicle to a backend server; and/or retrieve records of a release list from the backend server and transfer them to a database of the release module; and/or retrieve release information from the backend server and transfer it to the release module.

This embodiment is advantageous in that mobile terminal devices, especially commercially available smartphones, support communication via different networks (for example mobile network, WLAN, . . . ), while a communication module of a vehicle may be limited to certain radio technologies, such as a mobile network. On the other hand, mobile terminal devices are regularly located in environments where such connections can actually be established (for example through sufficient mobile network reception, a WLAN network in the vicinity of the mobile terminal device, . . . ). A communication module may not be able to establish a connection to a server if it can only communicate via mobile communications and the vehicle is located in a remote location or in an underground car park where there is not sufficient reception.

In this context, it can be advantageous to use the fact that there may be a time interval between A) the retrieval of records of the release list from the backend server by the mobile terminal device, after the transfer of the necessary information from the vehicle to the mobile terminal device, and B) the transfer of the records from the mobile terminal device to the vehicle. For example, the retrieval of records (for example through a BMW app on a smartphone) can be done at a time and place where the smartphone can establish an Internet connection via WLAN. The records can be transferred to the vehicle later in the vehicle, for example by the smartphone establishing a Bluetooth or WLAN connection to a head unit of the vehicle, which forwards the received records to the release module via a vehicle electrical system.

In other words, the mobile terminal device can act as a temporary memory to enable an update of the internal database of the release module, in situations where the vehicle cannot connect to the backend server via the communication module.

In addition, the technical advantages and effects of the system are similar to those already described in connection with the method discussed above.

It goes without saying that the features and the advantages that can be achieved in each case, which have been described in relation to the method discussed above are applicable or transferable to the devices of at least some embodiments.

Specifically, in the context of the present description, the components of the devices are designed to carry out the steps of the method discussed above. Likewise, the functions of the components of the devices discussed herein are applicable as steps of the method.

### BRIEF DESCRIPTION OF THE DRAWINGS

FIG. 1 shows a system according to at least one embodiment;

FIG. 2 shows the components of the vehicle from FIG. 1;

FIG. 3a shows a flow chart of the method for providing a service according to a first embodiment;

FIG. 3 shows a flow chart of the method for providing a service according to a second embodiment; and

FIG. 4 shows the contents of the release list on the backend server.

### DETAILED DESCRIPTION

In the following description, the same reference signs are used for parts that are the same and parts that have the same effect.

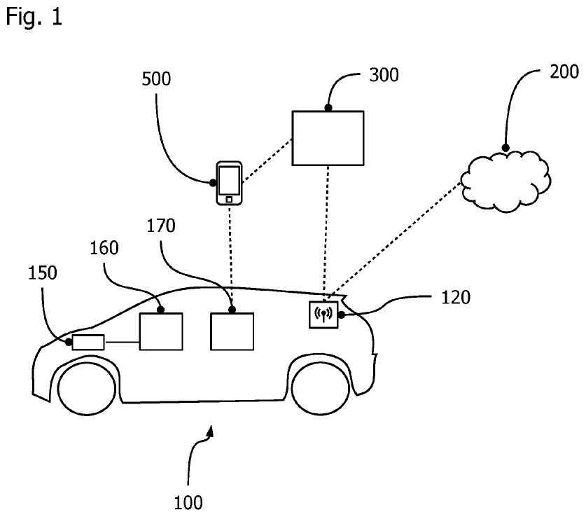

FIG. 1 shows the components of a system according to at least some embodiments, which contains a vehicle 100, a cloud service 200, a backend server 300 and a smartphone 500.

The vehicle 100 has a parking heater 150, which can be controlled by the cloud service 200. For this purpose, the control unit 160 of the parking heater 150 is designed to receive suitable commands via the onboard electrical system of the vehicle 100. Here, the cloud service 200 forms the external service component and the control unit 160 contains an onboard service component of the cooperative service provision.

Furthermore, the vehicle 100 has a communication module 120. This is designed to establish a communication connection to the cloud service 200 as well as to the backend server 300. The communication connection can be, for example, an LTE connection or other mobile or data connection (for example also a charging plug). In addition, the vehicle 100 has a head unit 170 as the central infotainment system.

The smartphone 500 is connected to the vehicle 100 via the head unit 170, for example via Bluetooth or WLAN. In addition, the smartphone 500 can connect to the backend server 300, for example via a mobile network or WLAN.

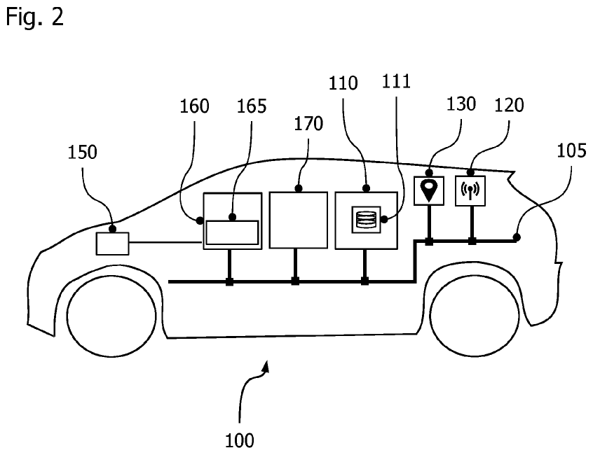

In FIG. 1, the communication links mentioned above are shown as dashed lines between two components of the system. Other components of the vehicle 100 are described below in connection with FIG. 2.

FIG. 2 shows an overview of all components of the vehicle 100 that are relevant to the description of the exemplary embodiment.

In addition to the components already mentioned, the vehicle 100 has in particular a release module 110 with an integrated database 111, which is designed to store records of a release list.

In order to control the communication of the onboard service component on the control unit 160 with the parking heater 150 according to release information determined by the release module 110, the control unit 160 has an integrated isolation module 165.

Furthermore, the vehicle 100 has a GPS module 130, which can determine a geographic position of the vehicle 100.

The control unit 160, the isolation module 165, the head unit 170, the release module 110, the GPS module 130 and the communication module 120 communicate with each other in the vehicle via the onboard electrical system 105.

Preferably, the vehicle 100 also has a time module (not shown), through which a secured time specification can be obtained. In particular, this can be a secured system time of the vehicle another secured time specification obtained via the communication module 120 or the GPS module 130.

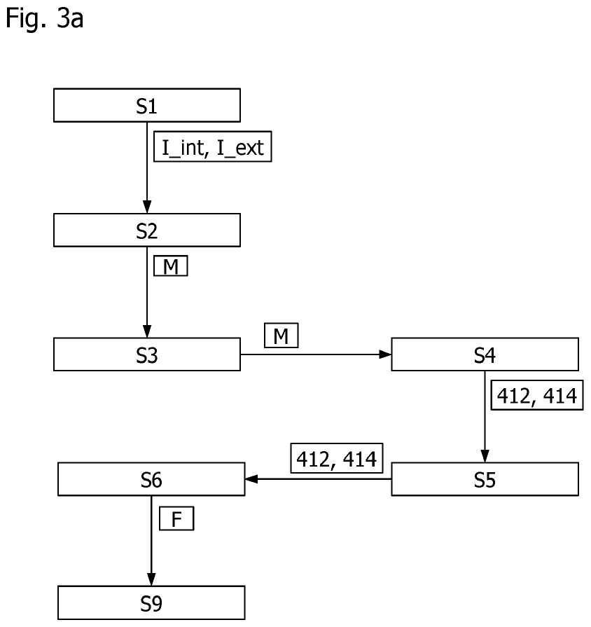

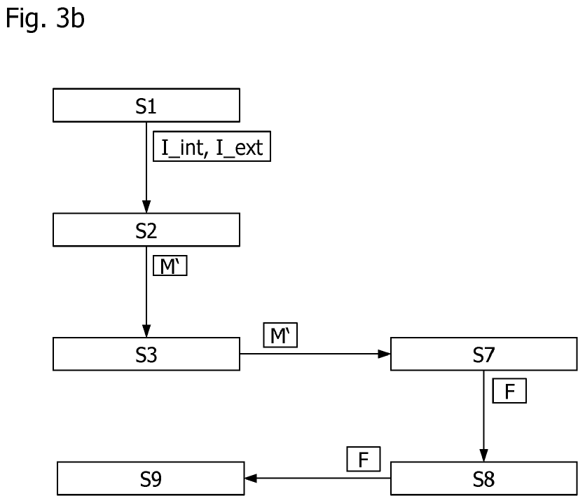

The method for providing the service, i.e. the control of the parking heater 150 via the cloud service 200, is described using FIGS. 3a and 3b.

FIG. 3a shows the method according to a first embodiment, in which determining the release information takes place in the vehicle 100.

In an initial registration step S1, a request from the cloud service 200 is received, in which the cloud service 200 requests a release to control the parking heater 150 as part of the cooperative service provision.

Subsequently, in step S1, identification codes I_ext, I_int of the service components involved are determined, according to this exemplary embodiment “HEATER_CONTROL_CLOUD” as the identification code of the cloud service 200 and “HEATER_CONTROL_VEHICLE” as the identification code of the onboard service component on the control unit 160.

In step S2, features M of the cooperative service provision are determined from the identification codes I_int and I_ext, wherein according to the described exemplary embodiment the features M contain the following information:
software version of the onboard service component on the control unit: 3.2;
software version of the cloud service: 11.0;
service requested: Control of the parking heater (“HEATER”).

In step S3, the features M are transferred from the the vehicle 100 to the backend server 300 via communication module 120.

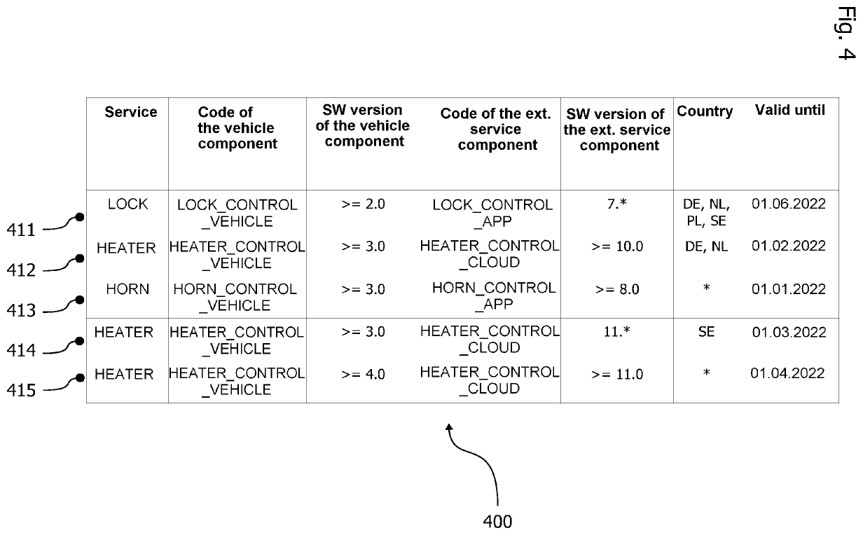

In step S4, the backend server 300 determines the records 412 and 414 of the release list, which are relevant for the cooperative service provision according to the received features M. The structure of the release list and how to determine the relevant records is explained in more detail below in connection with FIG. 4.

The determined records 412, 414 are first transferred in step S5 from the backend server 300 back to the communication module 120 of the vehicle 100. In the vehicle 100, the received records 414 and 414 are forwarded via the onboard electrical system 105 to the release module 110 and stored in the database 111.

In step S6, the release information F is determined by the release module 110. To do this, the release module queries the contents of the database 111, which contains in particular the two records 412 and 414. According to the two transferred records 412 and 414, the control of the parking heater 150 by the cloud service 200 is released if at least one of the following conditions (i) or (ii) is met:
(i) the software version of the vehicle component “HEATER_CONTROL_VEHICLE”, i.e. the onboard service component on the control unit 160, is 3.0 or higher; the software version of the external component “HEATER_CONTROL_CLOUD”, i.e. the cloud service 200, is 10.0 or higher; the GPS location of the vehicle 100 is in the DE or NL area; and the service will be performed until 01.02.2022;
(ii) the software version of the vehicle component “HEATER_CONTROL_VEHICLE”, i.e. the onboard service component on the control unit 160, is 3.0 or higher; the software version of the external component “HEATER_CONTROL_CLOUD”, i.e. the cloud service 200, is 11.*; the GPS location of the vehicle 100 is in the SE area; and the service will be performed until 01.03.2022.

Condition (i) corresponds to the record 412 and condition (ii) corresponds to the record 414. For further verification, the release module 110 retrieves the current GPS location of the vehicle 110 via the GPS module 130 well as as a current time designation including the date from a secured time source. For this example, it is assumed that the GPS location is in the DE area and the date of the time designation falls on Jan. 1, 2022.

The release module now checks whether at least one of the conditions (i) or (ii) is fulfilled based on the features M, the GPS location and the time designation. According to the data described above, this is the case for condition Consequently, the release module 110 creates release information F, which allows the control of the parking heater 150 by the cloud service 200 in the vehicle 100 until Jan. 2, 2022 at the latest.

Finally, in step S9, the release module 110 provides the determined release information F to the isolation module 165. The isolation module then releases 165 APIs to the communication interface between the onboard service component and the external service component, as well as APIs to the communication interface between the onboard service component and the parking heater 150 for the cooperative service provision in accordance with the determined release information F. The isolation module 165 therefore forwards data and control commands that relate to the cooperative service provision with the cloud service 200 to the parking heater 150 until the specified date.

FIG. 3b shows the method according to a second embodiment, in which the release information is not determined in the vehicle 100, but by the backend server 300.

Steps S1 to S3 in FIG. 3b are identical to the corresponding steps described above, except that in steps S2 and S3 respectively, the features M′ are determined or transferred. The features M′ contain the features M as described in connection with FIG. 3a, but also the determined GPS position and the time designation as described there.

In step S7, the backend server uses the compatibility list and the determined features M′ to determine release information F for the cooperative service provision. In contrast to the embodiment described in FIG. 3a, this is possible because the features M′ contain all the necessary data required for a complete test according to the release list.

In step S8, the determined release information F is first transferred from the backend server 300 back to the communication module 120 of the vehicle 100. In the vehicle 100, the release information is forwarded via the onboard electrical system 105 to the release module 110.

In step S9, the communication interfaces are again released, as described in connection with step S9 of FIG. 3a.

FIG. 4 shows the release list 400, which contains four records 411-415, each of which forms tuples of seven components. Each record 411-415 represents a time and spatially limited release of a service for a combination of a vehicle component and an external service component. For this purpose, each record 411-415 contains information about the service in question, identification codes of the vehicle component and the external service component, a software version (SW version) of the vehicle component, a SW version of the external service component, the geographic area and an expiration date. In the software versions, the relation >= is used to specify the set of all versions equal to or greater than the specified version number. An asterisk is a placeholder that can be replaced by any digit or country code.

Record 411 represents a release of the “LOCK” service for the vehicle component “LOCK_CONTROL_VEHICLE” with SW version 2.0 or higher and the external service component “LOCK_CONTROL_APP” of SW version 7.*. The release is valid in the countries DE, NL, PL and SE and until Jan. 6, 2022.

Record 412 represents a release of the “HEATER” service for the vehicle component “HEATER_CONTROL_VEHICLE” with SW version 3.0 or higher and the external service component “HEATER_CONTROL_CLOUD” of SW version 10.0 or higher. The release is valid in the countries DE and NL and until Jan. 2, 2022.

Record 413 represents a release of the “HORN” service for the vehicle component “HORN_CONTROL_VEHICLE” with SW version 3.0 or higher and the external service component “HORN_CONTROL_APP” of SW version 8.0 or higher. The release is geographically unlimited and valid until Jan. 1, 2022.

Record 414 represents a release of the “HEATER” service for the vehicle component “HEATER_CONTROL_VEHICLE” with SW version 3.0 or higher and the external service component “HEATER_CONTROL_CLOUD” of SW version 11.*. The release is valid in the country SE and until Jan. 3, 2022.

Record 415 represents a release of the “HEATER” service for the vehicle component “HEATER_CONTROL_VEHICLE” with SW version 4.0 or higher and the external service component “HEATER_CONTROL_CLOUD” of SW version 11.0 or higher. The release is geographically unlimited and valid until Jan. 4, 2022.

In the exemplary embodiment described above, the features M, M′, which are transferred to the backend server 300, contain at least the following information:
requested service: control of the parking heater (“HEATER”);
identification code of the vehicle component: HEATER_CONTROL_VEHICLE;
identification code of the external service component: HEATER_CONTROL_CLOUD;
software version of the control unit (=vehicle component): 3.2;
software version of the cloud service (=ext. service component): 11.0.

In the release list 400, only records 412, 414, and 415 refer to service. However, the specified the prerequisites formulated by record 415 do not apply to the features M, M′, since the software version of the vehicle component is less than 4.0. Therefore, in steps S4 and S5 from FIG. 3a, only the records 412 and 414 are determined to be relevant or transferred to the vehicle 100. In the embodiment of FIG. 3b, release information F based on the record 412 is determined directly on the basis of the features M′, since all prerequisites are met.

In the exemplary embodiment described above, the data transfer between the vehicle 100 and the backend server 300 is realized solely by the communication module 120 of the vehicle 100. Alternatively or additionally, the smartphone 500 can be used for this purpose. In particular, the smartphone 500 can receive features M from the vehicle 100 and send them to the backend server 300. Furthermore, the smartphone 500 can receive records of the release list and/or determined release information F from the backend server 300 and transmit them to the vehicle 100.

In the exemplary embodiment described in FIG. 3a, records are retrieved once from the backend server 300 and stored in the database 111 of the release module 110 for further use. According to at least some embodiments, an update of the database 111 may also be carried out on a regular basis or may be triggered by further events. For example, the update can be triggered on the vehicle side if, for example, relevant changes to the vehicle configuration have been detected. An update can also be triggered if a service is requested for which there is no matching record in the internal database, or if there is no record that would lead to a permitted execution. Finally, the release module can also be configured to carry out updates regularly, for example weekly. In addition, certain services require that an update be made before each execution and that the service will only be executed if there is updated release information.

The terms “module”, “unit”, “component” etc. used in this description describe units that can be implemented either in hardware or software, regardless of how it is stated in this description. Likewise, the units described can be arbitrarily combined or implemented separately from each other, without deviating from the substance of the invention.

At this point, it should be noted that all parts described above are to be regarded separately as independent embodiments or developments of the invention, as defined in particular in the introduction to the description and the claims-even without additional features described in the respective context, even if these are not explicitly identified as optional features in the respective context, for example by using: in particular, preferably, for example, e.g., if necessary, round brackets, etc.—and in combination or any sub-combination. Deviations from this are possible.

Specifically, it should be noted that the word particularly or round brackets do not denote any mandatory features in the respective context.

### LIST OF REFERENCE SIGNS

100 Vehicle
105 Onboard electrical system
110 Release module
111 Database
120 Communication module
130 GPS module
150 Parking heater
160 Control unit of the parking heater
165 Isolation module
170 Head unit
200 Cloud service
300 Backend server
400 Release list
411-415 Record
500 Smartphone
F Release information
I_ext Identification code of the external service component
I_int Identification code of the onboard service component
M, M′ Features
S1 Registration step
S2 Determining features
S3 Transferring features
S4 Determining records
S5 Transferring records
S6 Determining the release information (by the release module)
S7 Determining the release information (by the backend server)
S8 Transferring the release information
S9 Releasing an interface

1.-15. (canceled)

16. A method of providing a service in a vehicle wherein the service is provided using at least one onboard service component and an external service component, the method comprising:
receiving a request for provision of the service in the vehicle;
determining at least one identification code of at least one of the group consisting of the external service component and the onboard service component;
determining release information for a cooperative provision of services for the vehicle using a release list and the at least one identification code;
releasing, by a release module of the vehicle, to provide the service in accordance with the release information, at least one onboard interface for at least one of the group consisting of the onboard service component and for the external service component.

17. The method as claimed in claim 16, wherein determining the release information is carried out by the release module and the method further comprises:
determining features of the cooperative service provision;
transferring the features to a backend server using a mobile terminal device, using a communication module of the vehicle, or using the mobile terminal device and the communication module of the vehicle, wherein the release list is stored on the backend server;
receiving from the backend server records of the release list determined using the features;
transferring the records to a database of the release module,
wherein determining the release information by the release module is further carried out by using the records and by using the features of the cooperative service provision.

18. The method as claimed in claim 16, wherein determining the release information is carried out by a backend server and the method further includes:
determining features of the cooperative service provision;
transferring the features to the backend server, wherein the release list is stored on the backend server;
using the backend server to determine the release information using the features of the cooperative service provision;
transferring the release information from the backend server to the vehicle;
transferring the release information to the release module.

19. The method of claim 18, further comprising:
evaluating a validity of the release information at the release module using the features of the cooperative service provision.

20. The method as claimed in claim 16, wherein releasing the at least one interface according to the release information includes at least one of the group consisting of:
activating a software interface for use by an onboard service component;
activating a hardware component of the vehicle;
starting a software process in the vehicle; and
activating a communication interface.

21. The method as claimed in claim 20, wherein releasing the at least one interface according to the release information includes activating an onboard electrical system interface, network port, or a network connection in the vehicle.

22. The method as claimed in claim 16, wherein the service is a control of a parking heater, a horn or a locking system of the vehicle.

23. The method as claimed in claim 16, wherein the release list includes one or more of the group consisting of:
a set of attributes of onboard service components;
a set of attributes of external service components;
a set of identification codes of services or service scopes;
a set of attributes of the vehicle;
a set of attributes of an implementation environment of the external service component; and,
determining the release information includes a comparison with at least one of the group consisting of:
at least one attribute of the onboard service component;
at least one attribute of the external service component or implementation environment thereof; and
at least one attribute of the vehicle.

24. The method as claimed in claim 23, wherein the release list includes the set of attributes of the vehicle, and wherein the set of attributes of the vehicle comprises at least one of the group consisting of:
vehicle identification;
hardware and software components;
vehicle equipment;
country of vehicle registration;
country of vehicle user; and
geographic location of the vehicle.

25. The method as claimed in claim 16, wherein
at least one record of the release list includes a validity period specification; and
determining the release information includes a comparison of the validity period specification of the record with a system time, wherein the system time is a system time of at least one of the group consisting of: the vehicle; an implementation environment of the external service component; and a system time provided online or by satellite.

26. The method as claimed in claim 16, wherein
at least one record of the release list includes a geographic area statement; and
determining the release information includes a comparison of the geographic area statement of the record with a geographic location of at least one of the group consisting of the vehicle) and an implementation environment of the external service component.

27. The method as claimed in claim 16, wherein
at least one record of the release list or the release information is digitally signed and the method further comprises:
verifying at least a digital signature of a record or a digital signature of the release information by the release module.

28. The method as claimed in claim 16, wherein
at least one record of the release list contains at least one test condition; and
the method also includes determining whether the at least one test condition is met in the vehicle.

29. The method as claimed in claim 28, wherein the at least one test condition comprises at least one of the group consisting of an absence of a fault code in the vehicle; and a validity of a digital signature of a software module of the vehicle.

30. A non-transitory computer-readable storage medium containing instructions that cause at least one processor to implement a method as claimed in claim 16 when the instructions are executed by the at least one processor.

31. A release module in a vehicle, configured to:
determine features of a cooperative service provision in a vehicle between an onboard service component and an external service component;
receive or send a request regarding the provision of a service in the vehicle, wherein the request includes at least one of the group consisting of an identification code of an external service component and an identification code of an onboard service component;
receive records of a release list and store the records in a database of the release module;
determine release information for the cooperative service provision using the records of the release list and using respective current features of the cooperative service provision;
release at least one onboard interface for one of the group consisting of the onboard service component and for the external service component to provide the service according to the release information;
store the determine release information;
check the release information for validity; and
re-determine features of the cooperative service provision and checking whether validity of stored release information with regard to the re-determined features exists.

32. An isolation module in a vehicle,
wherein the isolation module is connected to the release module as claimed in claim 31; and
wherein the isolation module is configured to cause at least one control unit of the vehicle to activate or deactivate an interface for at least one of the group consisting of an onboard service component and an external service component by performing at least one of the group consisting of:
allowing or preventing the execution of software of the vehicle or the onboard service component;
forwarding or receiving first information on a communication path between the vehicle and the onboard service component;
forwarding or receiving the first information on a communication path between the onboard service component and the external service component;
sending fault codes on the communication path between the vehicle and the onboard service component;
sending fault codes on the communication path between the onboard service component and the external service component.

33. A vehicle comprising:
the release module as claimed in claim 31;
at least one isolation module, wherein the isolation module is configured to cause at least one control unit of the vehicle to activate or deactivate an interface for at least one of the group consisting of an onboard service component and an external service component by performing at least one of the group consisting of,
allowing or preventing the execution of software of the vehicle or the onboard service component,
forwarding or receiving first information on a communication path between the vehicle and the onboard service component,
forwarding or receiving the first information on a communication path between the onboard service component and the external service component,
sending fault codes on the communication path between the vehicle and the onboard service component, and
sending fault codes on the communication path between the onboard service component and the external service component;
the onboard service component;
the communication module;
wherein the vehicle is configured to provide the service.

34. The vehicle as claimed in claim 33, wherein the vehicle also comprises at least one of the group consisting of a position determining module and a mechanism for determining a system time provided onboard or outside the vehicle.

35. A system, comprising:
the vehicle as claimed in claim 33;
the external service component;
the backend server,
a mobile terminal device configured to perform at least one of the group consisting of:
transferring features of the cooperative service provision of the vehicle to the backend server;
retrieving records of the release list from the backend server; and
retrieving release information from the backend server and transfer it to the release module.
